(19) United States
(12) Patent Application Publication
(10) Pub. No.: US 2022/0039491 A1
(43) Pub. Date: Feb. 10, 2022

(54) SYSTEMS AND METHODS FOR MOLDABLE AND CASTABLE PERSONAL PROTECTIVE FACE MASKS

(71) Applicant: THE REGENTS OF THE UNIVERSITY OF CALIFORNIA, Oakland, CA (US)

(72) Inventors: Nadir Weibel, La Jolla, CA (US); Thomas Sharkey, San Diego, CA (US)

(21) Appl. No.: 17/394,229

(22) Filed: Aug. 4, 2021

Related U.S. Application Data
(60) Provisional application No. 63/061,648, filed on Aug. 5, 2020.

(51) Int. Cl. A41D 13/11; A62B 18/02; A62B 18/08; A62B 18/10; B29C 39/10; B29C 39/36; B29C 39/00; B29C 39/26

(52) U.S. Cl. CPC A41D 13/1146; A62B 18/025; A62B 18/084; A62B 18/10; B29K 2083/00; B29C 39/36; B29C 39/003; B29C 39/26; B29C 39/10

(57) ABSTRACT

Systems and methods for protecting a user from external contamination with a mask. Exemplary embodiments may include a mask including an open threaded portion couplable to a filter; one or more extrusions on a front of the unibody mask to mount straps to the unibody mask; wherein the mask is made of silicone, and wherein the unibody mask presses against a face such that the unibody mask seals an interior of the unibody mask from an exterior of the unibody mask.

### CROSS-REFERENCE TO RELATED APPLICATION

This application claims priority to, and the benefit of, U.S. Provisional Patent Application No. 63/061,648 filed on Aug. 5, 2020, entitled “SYSTEMS AND METHODS FOR MOLDABLE AND CASTABLE PERSONAL PROTECTIVE FACE MASKS”, which is incorporated herein by reference in its entirety.

### TECHNICAL FIELD

The present disclosure relates generally to a mask, and in particular, a mask that can protect a user from external contamination.

### BRIEF SUMMARY OF THE DISCLOSURE

An aspect of the present disclosure relates to a unibody mask. The unibody mask may include an open threaded portion couplable to a filter. The threaded portion may be adjacent to a mouth. The unibody mask may also include one or more extrusions on a front of the unibody mask to mount straps to the unibody mask. The unibody mask may be made of silicone. The unibody mask may press against a face such that the unibody mask seals an interior of the unibody mask from an exterior of the unibody mask.

In embodiments, the unibody mask may also include one or more ports and corresponding filters to provide for dedicated valves for inhalation and exhalation.

In embodiments, the unibody mask may include a large inner lip that is in contact with the face.

In embodiments, the open threaded portion may include a filter adapter.

In embodiments, the unibody mask may further include slots on the front of the unibody mask to mount a nose piece to create a seal around a nose.

In embodiments, the silicone may have a shore hardness between 30A and 45A.

In embodiments, the unibody mask may include one or more of PLA, ABS, Nylon, and TPU.

An aspect of the present disclosure relates to a mask. The mask may include a body. The body may include a plastic. The mask may also include a face interface portion coupled to the body that presses against a face such that the mask seals an interior of the mask from an exterior of the mask. The face interface portion may include silicone. The mask may also include an open threaded portion couplable to a filter. The open threaded portion may be adjacent to a mouth. The mask may also include one or more extrusions on a front of the mask to mount straps to the mask.

In embodiments, the mask may further include one or more ports and corresponding filters to provide for dedicated valves for inhalation and exhalation.

In embodiments, the mask may further include a large inner lip that is in contact with the face.

In embodiments, the open threaded portion may include a filter adapter.

In embodiments, the mask may further include slots on the front of the mask to mount a nose piece to create a seal around a nose.

In embodiments, the silicone may have a shore hardness between 30A and 45A.

In embodiments, the mask may include one or more of PLA, ABS, Nylon, and TPU.

An aspect of the present disclosure relates to a method of making a mask. The method may include one or more steps. One step may include fitting one or more base pieces that form a cup. The cup may include a threaded recess that forms a thread interface. The cup may also include one or more conical recesses. Another step may include pouring silicone into the cup. Yet another step may include pressing a top piece into the cup to form a semi-closed cup. The top piece may include a hollowed-out area. Another step may include pressing one or more triangular pieces on the top piece of the semi-closed cup. Yet another step may include releasing a molded mask from the semi-closed cup.

In embodiments, another step may include applying a release to an inside of the one or more base pieces, the top piece, and the one or more triangular pieces before silicone is poured into the cup.

In embodiments, the release may include petroleum jelly.

In embodiments, another step may include securing the one or more base pieces to the top piece and the one or more triangular pieces using one or more of pins, ties, string, and clamps.

In embodiments, the silicone may be 2-part silicone mixed at a 1:1 ratio by volume.

In embodiments, the cup may further include one or more slots to receive a metal strip.

An aspect of the present disclosure relates to a mold to make a mask. The mold may include one or more base pieces configured to fit together to form a cup. The cup may include a threaded recess that forms a thread interface. The cup may also include one or more conical recesses. The mold may also include a top piece configured to fit on top of the cup, thereby forming a semi-closed cup. The top piece may include a hollowed-out area. The mold may also include one or more triangular pieces configured to fit on the top piece of the semi-closed cup.

### BRIEF DESCRIPTION OF THE DRAWINGS

The technology disclosed herein, in accordance with one or more various embodiments, is described with reference to the following figures. The drawings are provided for purposes of illustration and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates an example mask, in accordance with various embodiments of the present disclosure.

FIG. 2 illustrates example mold pieces, in accordance with various embodiments of the present disclosure.

FIG. 3 illustrates example mold pieces, in accordance with various embodiments of the present disclosure.

FIG. 4 illustrates a component of the example mask, in accordance with embodiments of the present disclosure.

FIG. 5 illustrates a component of the example mask, in accordance with embodiments of the present disclosure.

FIG. 6 illustrates a component of the example mask, in accordance with various embodiments of the present disclosure.

FIG. 7 illustrates a component of the example mask, in accordance with various embodiments of the present disclosure.

FIG. 8 illustrates an example mask, in accordance with various embodiments of the present disclosure.

FIG. 9 illustrates an example mask, in accordance with various embodiments of the present disclosure.

The figures are not intended to be exhaustive or to limit the presently disclosed technology to the precise form disclosed. It should be understood that the presently disclosed technology can be practiced with modification and alteration, and that the disclosed technology be limited by the claims and the equivalents thereof.

### DETAILED DESCRIPTION OF THE EMBODIMENTS

COVID-19 has caused a global dismantling of various institutions-preventing individuals from meeting and working in close contact with others, for fear of spreading the virus. To mitigate this effect, to allow for the safe undertaking of everyday tasks, like picking up groceries, and to protect essential workers, the CDC, WHO, and other health organizations have all recommended use of face masks in public. Face masks, however, quickly became difficult to find, spurring a surge in DIY masks that primarily use fabric or other flexible material to house a small piece of filter material.

DIY masks, surgical masks, and even common N95 masks all face a similar flaw, however, they do not create a reliable seal against the face. Without a seal, inhaled air is sucked in through the gaps between the face and mask-bypassing the filter material and exposing the wearer to the unfiltered air and any airborne particulates that would normally be filtered by a mask. Without a proper seal, face masks are effectively useless in protecting the wearer from contracting COVID-19. Their value actually comes from diffusing the wearer's exhalation and preventing an infected wearer from spreading the virus to others.

In hospitals, however, it is often impossible to give infected patients a mask, as they often need respiratory support (via oxygen supply or intubation) with tubing across the face—preventing the patient from wearing a mask. In this situation, hospital workers need masks that can protect them when entering a patient's room—ruling out the more common mask options.

The presently disclosed technology is directed toward a mask that protects the wearer from contracting COVID-19, as opposed to a mask that prevents the wearer from spreading the virus. For example, the presently disclosed mask includes one or more of the following features: the mask can seal to the face easily and consistently; the mask can accept various filters to accommodate limitations in commercial stock; the mask can be easily sanitized using existing methods like autoclaving, baking in the oven, hand washing with soap and water, wiping down with alcohol, or being put in the dishwasher; the mask can be made at home and anywhere in the world. The materials discussed herein can be used by anyone and may be found in a local hardware store, which enables both those with and without 3D printers to make the presently disclosed technology by providing molds for the pieces they cannot print. These molds would be reusable and capable of making enough masks for a small group (or large group with more time investment).

In embodiments, the mask may be created using one or more steps. One step may include making and/or acquiring the molds. Making and/or acquiring the molds may include a number of steps as well. In one example, using a 3D printer, the following settings may be used:
No Supports
No Raft
0.3 mm layer height
20% infill (triangles)
1.3 mm wall thickness
70 mm/s print speed
   It should be understood that these settings are merely exemplary, and other setting can vary to make molds supported by the presently disclosed technology.

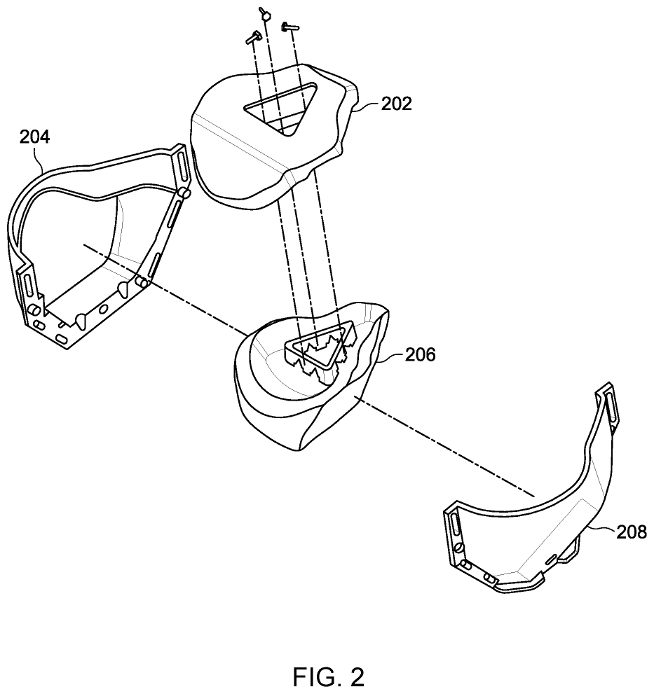

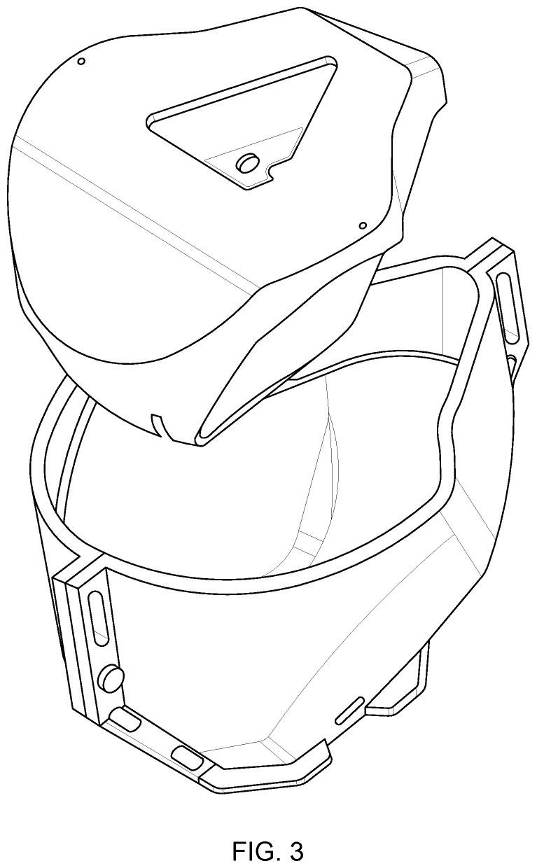

FIG. 2 illustrates example mold pieces, in accordance with various embodiments of the present disclosure. In one example of making the mold, the left 204 and right 208 base pieces may be fit together with center 206 piece to form a cup. In embodiments, pins (shown at the top) may be used to help with alignment, and slots may be used for the zip-ties, string, and/or other material. In one example, clamps can be used instead. Next, the core (e.g., 204, 206, 208) and top pieces 202 may be fit together. Another illustration of this is shown in FIG. 3. In another step, the triangular pieces (e.g., 204, 208) may fit together on the thicker part of the top piece (e.g., 202, leaving the hollowed out area on top to help separate the mold later). In embodiments, the two pieces of FIG. 3 may form a tight enough fit to stay together on their own. In some embodiments, if there is too much slop between the two pieces of FIG. 3, pins may be used to hold them together. Referring back to FIG. 2, in another step, the silicone may be poured into the cup 206, and the other two pieces (e.g., 204, 208) may be pressed into the cup 206. In another step, the petroleum jelly or mold release may be applied to the inside of the mold. In embodiments, a thin layer may be applied over some or all of the internal pieces, 202, 204, 206, 208. The mold release may be used to help disassemble the mold after pouring the silicone. This may help make the pieces and silicone slide apart more easily. In embodiments, the petroleum jelly may be used to seal any cracks in the mold.

Another step may include casting the silicone. The silicone may be cast using 2-part silicone, and the molds can be made with any common 3D printer. This step may include mixing silicone. In some embodiments, 2-part silicone may be mixed at a 1:1: ratio by volume. Once combined, parts A and B of the silicone mix may be mixed together. The mixed silicone may be poured into the cup-like part of the mold, as discussed herein. The other pieces may be pressed into the cup-like part. Pushing may be stopped when the pieces of the mold align. The mold be left for 10 minutes to over 24 hours to cure. The mold may be pulled apart afterward. The clamped/tied pieces can be unfastened and pried apart. The last 2 pieces may be detached.

In one example, casting the silicone may include about % cup of low tear, 30A-45A durometer, 2-part silicone. The mold may be partially assembled to form a cup/bowl-like structure and a plug. The mold may use a squeeze-mold casting process. The silicone may be mixed by hand using a stirring rod and may be poured into the cup-like portion of the mold. The ‘plug’ may then be pressed into the ‘cup’, forcing the silicone to squeeze into the cracks and crevices of the mold. The mold may be designed to contain any extra silicone, collecting it in the center to contain most of the mess associated with casting. The silicone may then be left to cure in the mold. Depending on the silicone used, this may take anywhere from 30 minutes to several hours. Once cured, the mold may be pulled apart. In some embodiments, extra holes and lips may be added to the mold to help with pulling things apart. Once the mask is free of the mold, any flashing (e.g., extra material that seeped along mold lines) can be easily trimmed and the mask can be washed by hand or put in the dishwasher to clean.

Yet another step may include adding the filter and head straps. The mask may include conical extrusions in front to allow for the straps to be pressed into place or tied around. In some embodiments, straps may be generated using a 3D printer. In embodiments, holes may be made a piece of plastic/cardboard/old credit card/etc. for fastening to the mask. In embodiments, if nothing rigid is available, the elastic band can be directly tied around the conical extrusions. Depending on the filter desired, a filter attachment may be 3D printed or cast, as discussed herein.

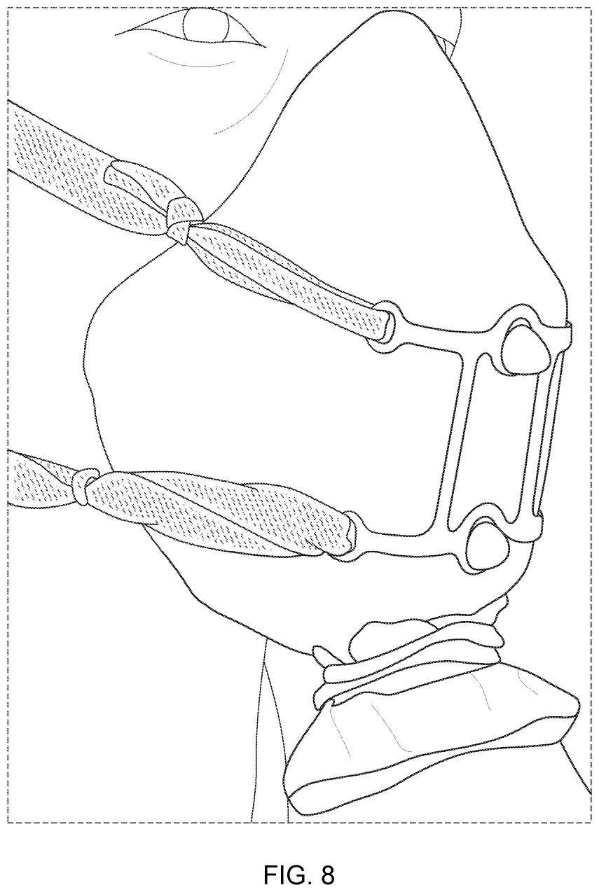

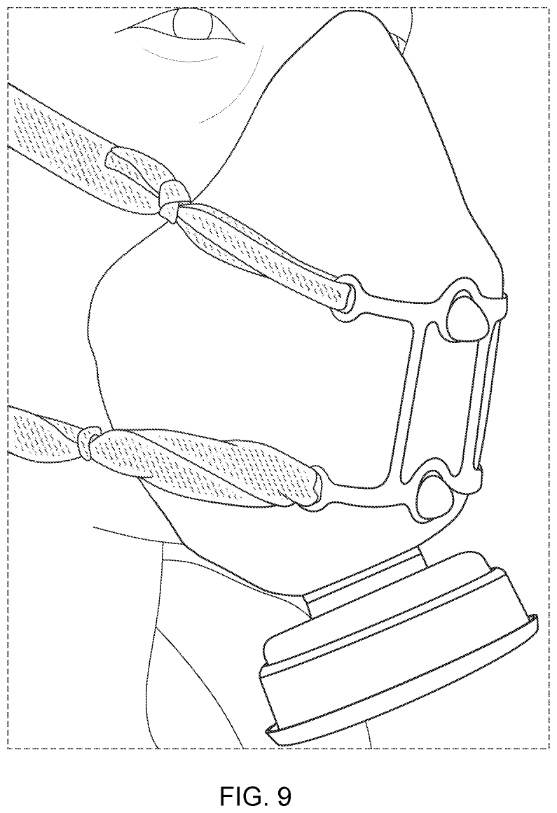

The filter may include using a filter adapter to accommodate commercial filters (see FIG. 8) or another filter adapter to fit customized filters (see FIG. 9), as discussed herein. The filter with the filter adapter may be coupled to the mask. FIG. 8 illustrates an example mask, in accordance with various embodiments of the present disclosure. This example filter adapter may include a conical shape that allows Halyard material, or other filtration materials, to be wrapped around the bottom and tied off using a rubber band or other like material. A surgical mask or other filter material may be coupled to the filter adapter using a rubber band or other suitable material. FIG. 9 illustrates an example mask, in accordance with various embodiments of the present disclosure. The lower portion with a different color may be coupled to the mask via the filter adapter. This example adapter may include a screw-on thread that interfaces with commercial filters.

In some embodiments, the filters may be cast. The filters may be cast by performing one or more steps. One step may include printing the mold space and the filter structure. One step may include assembling the 3 pieces and pouring silicone into the mold space to create the mold, based on the steps described above. After breaking the mold apart, a new silicone piece may be used as a mold, and polyurethane may be mixed and poured into the silicone mold. In some embodiments, the polyurethane may be a 2 part hard (e.g., about 40D durometer) polyurethane. The silicone mold may be unfolded/flipped inside out to release the polyurethane piece. The polyurethane filter port may be inserted into the mask.

The head straps may be made by creating a head strap mount. Elastic bands or other like materials may be coupled to the head strap mount. The resulting head strap may be coupled to the mask. In some embodiments, a method to create the head strap may include one or more of the following steps:
Cut 2 strips of a flexible material like a sheet of plastic or cardboard. Cut rectangles between 5×2 cm and 13×2.5 cm (i.e., 2×¾ inch and 5×1 inch).
Cut/punch 3 holes—2 on one end, and 1 in the center
Tie elastic bands or other material to through the end holes
Press the center holes through the conical extrusions on the mask

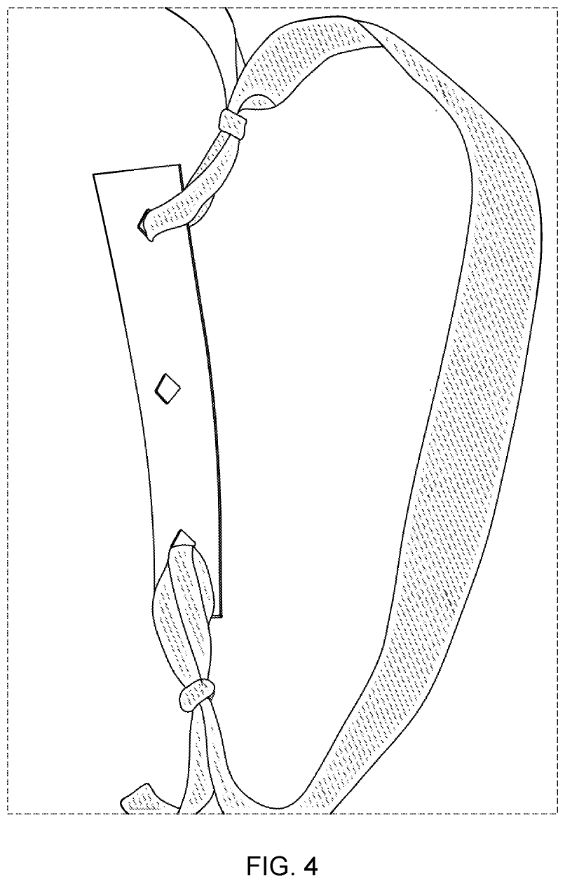

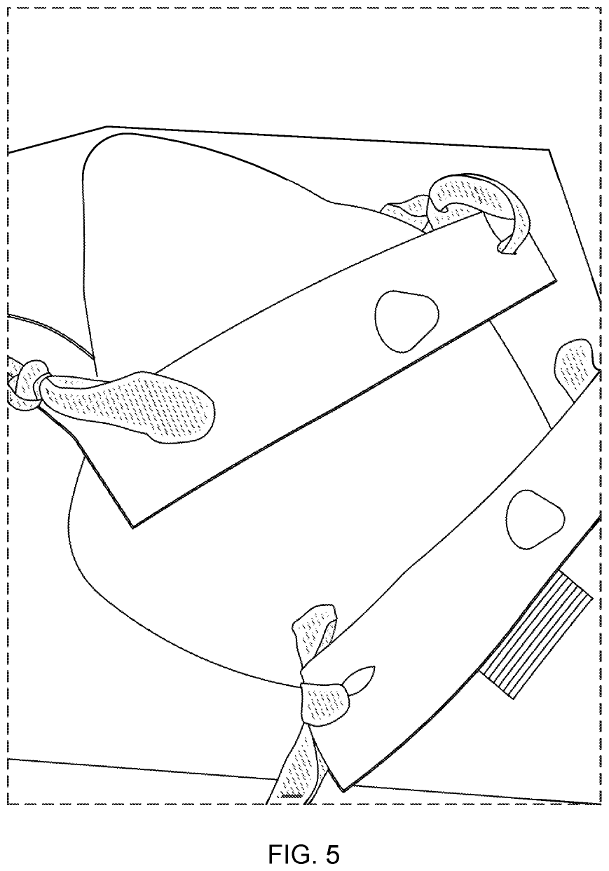

FIG. 4 illustrates a component of the example mask, in accordance with embodiments of the present disclosure. One example of the straps is shown based on the above method. This strap includes plastic coupled to elastic bands. FIG. 5 illustrates a component of the example mask, in accordance with embodiments of the present disclosure. Two example straps are shown based on the method used to make the strap of FIG. 4. These two example straps may be mounted to an example mask via conical extrusions. The conical extrusions may help secure the straps to the mask. The threaded portion at the bottom of the mask may be used to attach a filter. In some embodiments, the threaded portion may be a filter adapter.

The materials for the mask may include silicone, with additional materials used for straps and filters, as discussed herein. For example, 2-part silicone may be used. In some examples, the silicone may have a shore hardness between 30A and 45A, though it should be appreciated that other levels of shore hardness may be used (e.g., 25A 50A, and so on). In examples, the silicone may be low tear silicone. It is popular in medical applications due to its extreme chemical and temperature durability, allowing it to be easily sanitized with a variety of methods. To ensure a stable seal, the mask has a large inner lip that makes contact with the face-keeping a seal even while the mask is moved on the face. The presently disclosed technology may also include other materials for making the mask, such as, for example, PLA or other filaments (e.g., ABS, Nylon, TPU, flexible PLA)), petroleum jelly (e.g., including other materials that can help release the cast mask from the mold), clamps (e.g., including string, zip ties, and the like), and other materials, as discussed herein.

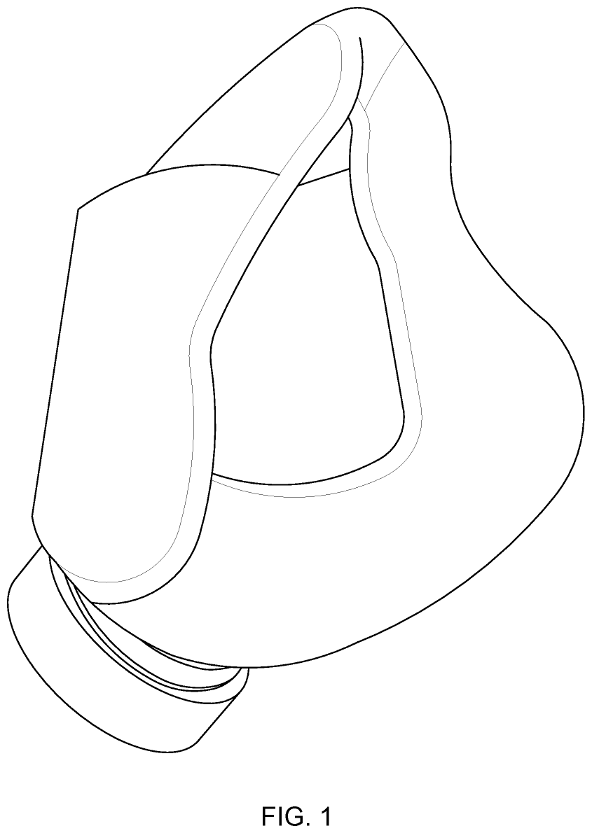

FIG. 1 illustrates an example mask, in accordance with various embodiments of the present disclosure. The mask may include a component that interfaces directly with a user's face, a component blocking outside particulates, and a filter component, as described herein.

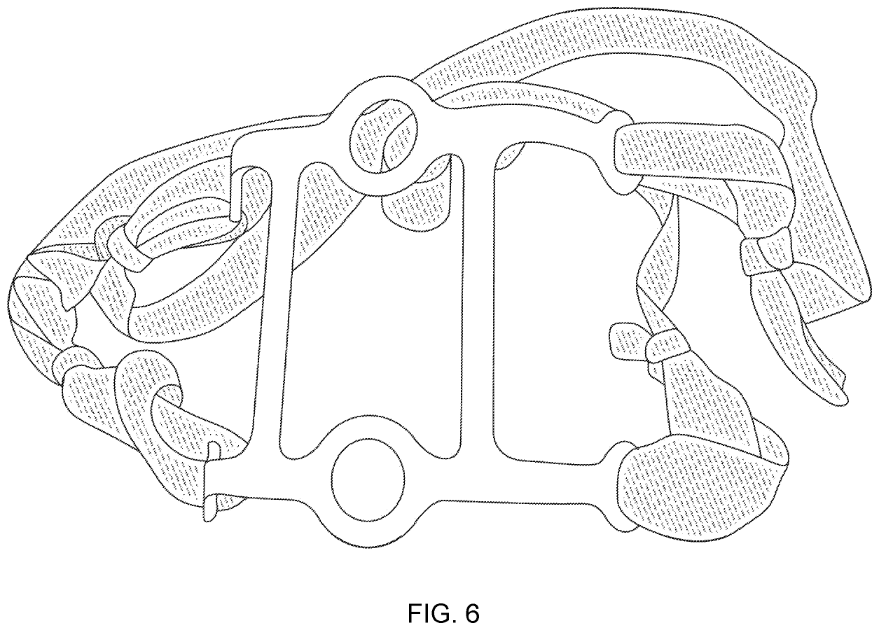

FIG. 6 illustrates a component of the example mask, in accordance with various embodiments of the present disclosure. The component may be a head strap mount. This may couple directly with the mask body. In embodiments, the head strap mount may be coupled to elastic bands to secure the mask to a user's face. In some embodiments, the head strap mount may include an interface for elastic band to be coupled to.

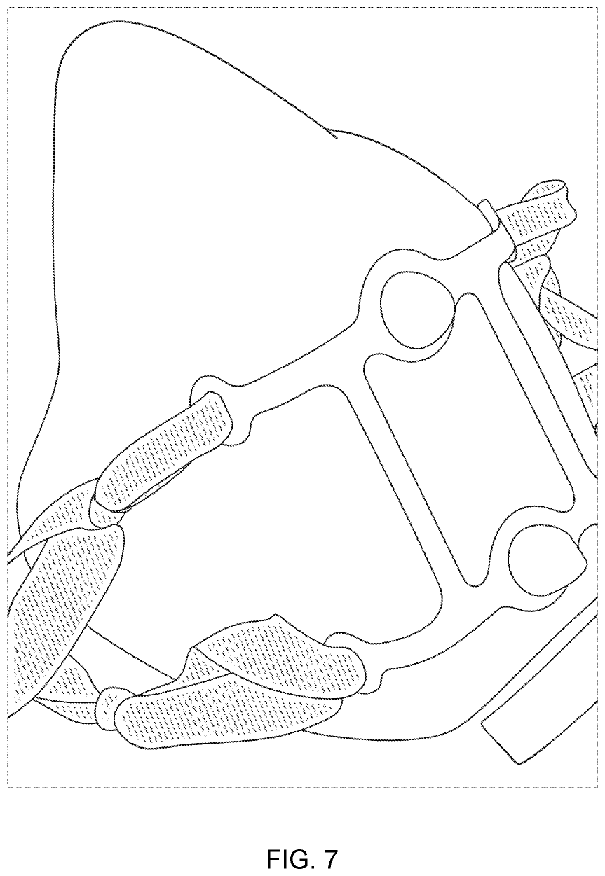

FIG. 7 illustrates a component of the example mask, in accordance with various embodiments of the present disclosure. The head strap mount may be mounted to an example mask via conical extrusions. The conical extrusions may help secure the straps to the mask. The threaded portion at the bottom of the mask may be used to attach a filter. In some embodiments, the threaded portion may be a filter adapter.

Fit testing was performed using a PortaCount Plus 8020 machine, which provides a quantitative measure of a mask's fit to a person's face by comparing submicron particles inside and outside of a worn mask. This may be accomplished using a continuous-flow Condensation Nucleus Counter which uses a laser, photodetector, alcohol vapor, and collection screen to measure particulates. As a result, the raw submicron particle flow rate through a material can be calculated. The fit test is a ratio and average of these measurements to provide a single number representing the overall protection a mask is providing. Crucially this is affected by both filter material and any gaps or leaks in the mask's seal around the face. Fit tests vary between individuals, and higher numbers are better. The test measured fit during normal breathing.

| | Our | | | | Surgical |
|---|---|---|---|---|---|
| | Silicone | N95 | N95 | N95 | Mask |
| Mask | Mask | (reference) | (reference) | (reference) | (reference) |
| Individual | 1 (bearded) | 2 | 2 (repeat) | 3 | 1 |
| Fit (higher | 55 | 5.9 | 79 | 39 | ~1.4 |
| is better) | | | | | |
| Calculated | 1.8% | 16.8% | 1.2% | 2.5% | ~70% |
| Leakage | | | | | |
| (lower is | | | | | |
| better) | | | | | |

The above data reflects known issues in N95 masks. It shows how both between individuals and within individuals, the way someone wears the mask dramatically influences its performance. Individuals 2 and 3 show a Fit Factor difference of >30 (e.g., >14% difference in how much air is leaked into the mask from the outside). Even more dramatic is in individual 2's repeat test, showing how changing the mask position dramatically increased its fit.

In some embodiments, more ports may be added, adding more filtration surface area to the mask and allowing for more airflow. The increased airflow may prevent pressure build up and allows for the voice to carry more easily.

In embodiments, more ports may be added, and different filters can be designated for inhalation and exhalation. Many commercial masks have 2 inhalation filters on the sides of the mask, and a ‘purge valve’ on the bottom of the mask. This allows the wearer to inhale clean air and exhale unfiltered air. While this design would be ineffective in reducing the spread of a virus (e.g., the purge valve does not have a filter so the wearer can exhale contaminated air into the room), adding a filter to the purge valve would be extremely effective.

There is an inherent problem with using a filter for both inhalation and exhalation. When inhaling, particulates (i.e., like a virus) are sucked into the filter and trapped on its exterior surface. This keeps the interior air clean-which is good. The problem arises on the exhale, when air is blasted back out of the same filter, potentially causing any particulates on the exterior surface to be launched off of the filter and aerosolized. The presently disclosed technology may include adding one-way valves to a mask with multiple filters that allows the air passing through a filter to travel in one direction. This may eliminate the risk of re-aerosolization.

Because there is no metal nose piece allowing for a customizable nose shape, existing mask straps may be excessively tightened to create a seal around the nose. This could be solved by adding slots for an aluminum strip to be added. In embodiments, slots in the mask may be added for an aluminum strip.

In some embodiments, the lip around the face may be cast, and the rest of the mask may be 3D printed or otherwise made from a hard plastic.

While various embodiments of the disclosed technology have been described above, it should be understood that they have been presented by way of example, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent component names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the components or functionality described or claimed as part of the component are all configured in a common package. Indeed, any or all of the various components of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A unibody mask comprising:
an open threaded portion couplable to a filter, wherein the threaded portion is adjacent to a mouth; and
one or more extrusions on a front of the unibody mask to mount straps to the unibody mask; and
wherein the unibody mask is made of silicone, and wherein the unibody mask presses against a face such that the unibody mask seals an interior of the unibody mask from an exterior of the unibody mask.

2. The unibody mask of claim 1, further comprising one or more ports and corresponding filters to provide for dedicated valves for inhalation and exhalation.

3. The unibody mask of claim 1, wherein the unibody mask comprises a large inner lip that is in contact with the face.

4. The unibody mask of claim 1, wherein the open threaded portion comprises a filter adapter.

5. The unibody mask of claim 1, further comprising slots on the front of the unibody mask to mount a nose piece to create a seal around a nose.

6. The unibody mask of claim 1, wherein the silicone has a shore hardness between 30A and 45A.

7. The unibody mask of claim 1, wherein the unibody mask comprises one or more of PLA, ABS, Nylon, and TPU.

8. A mask comprising:
a body comprising a plastic;
a face interface portion coupled to the body that presses against a face such that the mask seals an interior of the mask from an exterior of the mask, wherein the face interface portion comprises silicone;
an open threaded portion couplable to a filter, wherein the open threaded portion is adjacent to a mouth; and
one or more extrusions on a front of the mask to mount straps to the mask.

9. The mask of claim 8, further comprising one or more ports and corresponding filters to provide for dedicated valves for inhalation and exhalation.

10. The mask of claim 8, wherein the mask comprises a large inner lip that is in contact with the face.

11. The mask of claim 8, wherein the open threaded portion comprises a filter adapter.

12. The mask of claim 8, further comprising slots on the front of the mask to mount a nose piece to create a seal around a nose.

13. The mask of claim 8, wherein the silicone has a shore hardness between 30A and 45A.

14. The mask of claim 8, wherein the mask comprises one or more of PLA, ABS, Nylon, and TPU.

15. A method of making a mask, comprising:
fitting one or more base pieces that form a cup, wherein the cup comprises:
a threaded recess that forms a thread interface; and
one or more conical recesses;
pouring silicone into the cup
pressing a top piece into the cup to form a semi-closed cup, wherein the top piece comprises a hollowed-out area;
pressing one or more triangular pieces on the top piece of the semi-closed cup; and
releasing a molded mask from the semi-closed cup.

16. The method of claim 15, further comprising applying a release to an inside of the one or more base pieces, the top piece, and the one or more triangular pieces before silicone is poured into the cup.

17. The method of claim 16, wherein the release comprises petroleum jelly.

18. The method of claim 15, further comprising securing the one or more base pieces to the top piece and the one or more triangular pieces using one or more of pins, ties, string, and clamps.

19. The method of claim 15, wherein the silicone is 2-part silicone mixed at a 1:1 ratio by volume.

20. The method of claim 15, wherein the cup further comprises one or more slots to receive a metal strip.

21. A mold to make a mask, comprising:
one or more base pieces configured to fit together to form a cup, wherein the cup comprises:
a threaded recess that forms a thread interface; and
one or more conical recesses;
a top piece configured to fit on top of the cup, thereby forming a semi-closed cup, wherein the top piece comprises a hollowed-out area; and
one or more triangular pieces configured to fit on the top piece of the semi-closed cup.
